(19) United States
(12) Patent Application Publication
(10) Pub. No.: US 2026/0210395 A1
(43) Pub. Date: Jul. 23, 2026

(54) IMPACT SCREW

(71) Applicant: EVERWIN PNEUMATIC CORPORATION, Taichung City (TW)

(72) Inventor: JUI-CHANG WANG, TAICHUNG CITY (TW)

(21) Appl. No.: 19/027,523

(22) Filed: Jan. 17, 2025

(51) Int. Cl. F16B 25/10; F16B 25/00

(52) U.S. Cl. CPC F16B 25/103; F16B 25/0073

(57) ABSTRACT

An impact screw includes a head part, a shaft part, a tail part, and a chip removal groove. The shaft part is connected with the head part and has a threaded section and a smooth section connected between the threaded section and the head part. The smooth section has a first outer diameter. The threaded section has a second outer diameter and a thread root diameter. The second outer diameter is greater than the first outer diameter. The threaded section has threads, each having a pitch. The thread root diameter is smaller than double the pitch. The tail part is on one end of the shaft part. The chip removal groove extends from the threaded section toward the tail part. Arrangement direction of the chip removal groove is opposite to the threading direction of the threaded section, improving the smoothness of the impact screw entering an object.

### BACKGROUND OF THE DISCLOSURE

### 1. Field of the Disclosure

The present disclosure relates to impact screws, and more particularly, to an impact screw with chip removal groove.

### 2. Description of the Related Art

When using a nail gun to carry out a fastening operation with a conventional screw, an impact force is applied to achieve the fixing effect. However, due to limitations in the screw structure or the situation of encountering harder materials, the conventional screwing method often lacks sufficient penetration power, failing to provide adequate fixing strength, resulting in issues of unstable fastening of object.

### SUMMARY OF THE DISCLOSURE

To resolve issues above, the present disclosure provides an impact screw, which has a chip removal groove extending from the threaded section toward the tail part for smoothly removing chips, thereby improving the penetration effect and fixing effect of the impact screw.

For achieving the aforementioned objectives, an embodiment of the present disclosure provides an impact screw for use with a nail gun, the impact screw comprising:

a head part;

a shaft part connected with the head part, the shaft part having a threaded section and a smooth section, the smooth section connected between the threaded section and the head part, the smooth section having a first outer diameter, the threaded section having a second outer diameter and a thread root diameter, the second outer diameter being greater than the first outer diameter, the threaded section comprising a plurality of threads, each of the threads having a pitch, the thread root diameter being smaller than double the pitch;

a tail part disposed on one end of the shaft part away from the head part; and

a chip removal groove extending from the threaded section toward the tail part, wherein an arrangement direction of the chip removal groove is opposite to a threading direction of the threaded section.

With such configuration, the chip removal groove is arranged on the threaded section and extends to the tail part, and the arrangement direction of the chip removal groove is opposite to the threading direction of the threaded section, so as to effectively discharge chips and reduce the frictional resistance during insertion, thereby ensuring the smoothness of the operation.

### BRIEF DESCRIPTION OF THE DRAWINGS

FIG. 1 is a perspective view of the impact screw in accordance with the first embodiment of the present disclosure.

FIG. 2 is a side view of the impact screw in accordance with the first embodiment of the present disclosure.

FIG. 3 is a partially enlarged view of FIG. 2.

FIG. 4 is a cross-sectional view taken along line A-A in FIG. 2, displaying the sectional face of the chip removal groove.

FIG. 5 is a side view of multiple impact screws of the present disclosure being placed in the retainer.

FIG. 6 is a side view of the impact screw in accordance with the second embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion. Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features.

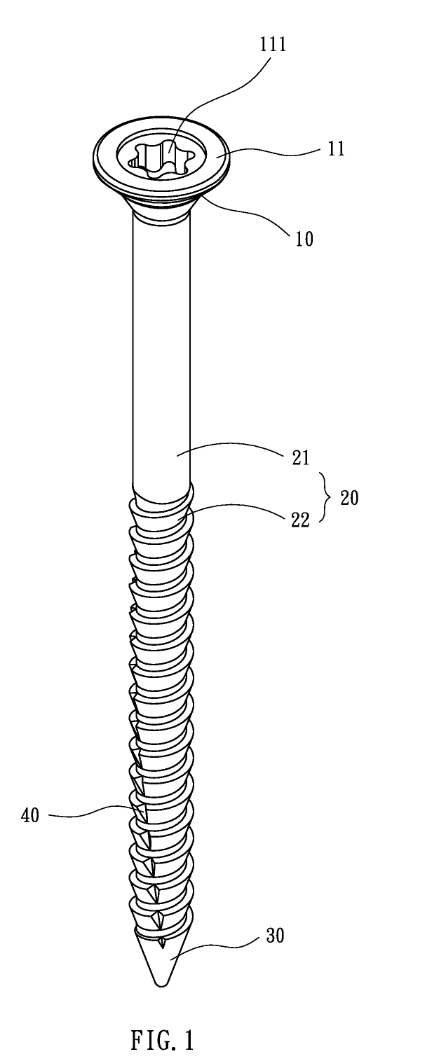

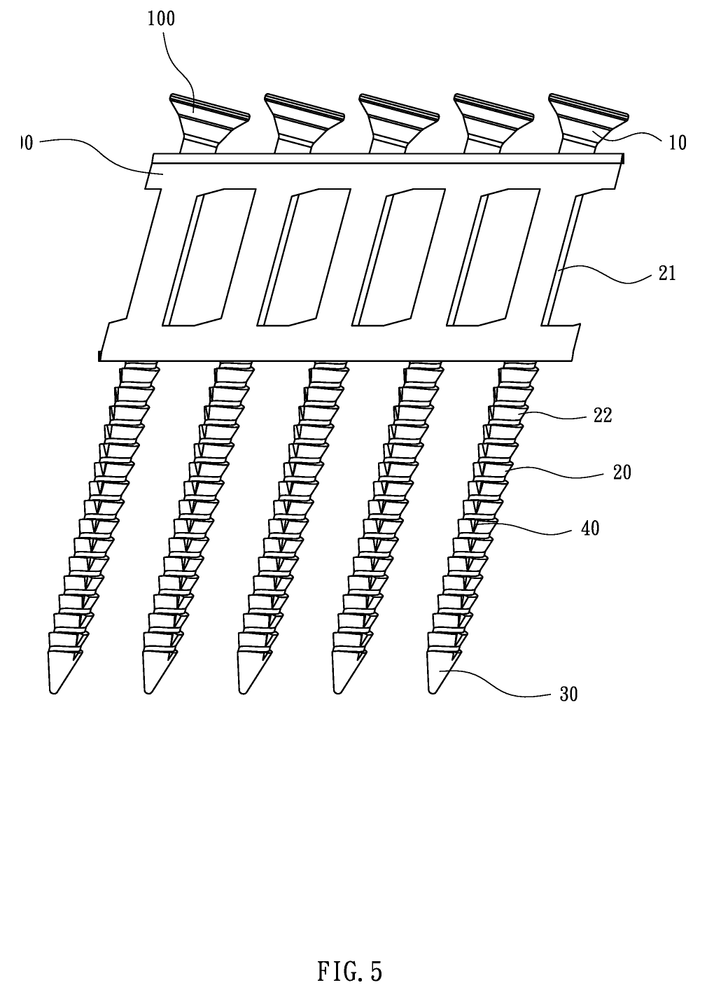

Referring to FIG. 1 to FIG. 5, an embodiment of the present disclosure provides an impact screw 100, comprising a head part 10, a shaft part 20, a tail part 30, and a chip removal groove 40. Therein, as shown by FIG. 5, the present disclosure is for use with a nail gun, so that a plurality of impact screws 100 are allowed to be retained in an inclined and parallel arrangement through a retainer 200.

The head part 10 comprises a top face 11, a first taper section 12, and a second taper section 13. The first taper section 12 is connected between the top face 11 and the second taper section 13. The second taper section 13 neighbors the shaft part 20. The first taper section 12 defines a first neck angle 121, and the second taper section 13 defines a second neck angle 131, wherein the first neck angle 121 is greater than the second neck angle 131, so as to facilitate the head part 10 being embedded into the surface of the to-be-fixed object. Also, the top face 11 comprises a concave tool groove 111, which is a star-shaped bore, with which a screw driver with a star-shaped sectional face is inserted for use.

In the embodiment, the first neck angle 121 ranges from 88 degrees to 92 degrees, and the second neck angle 131 ranges from 58 degrees to 62 degrees. In another embodiment, the first neck angle 121 is 90 degrees, and the second neck angle 131 is 60 degrees.

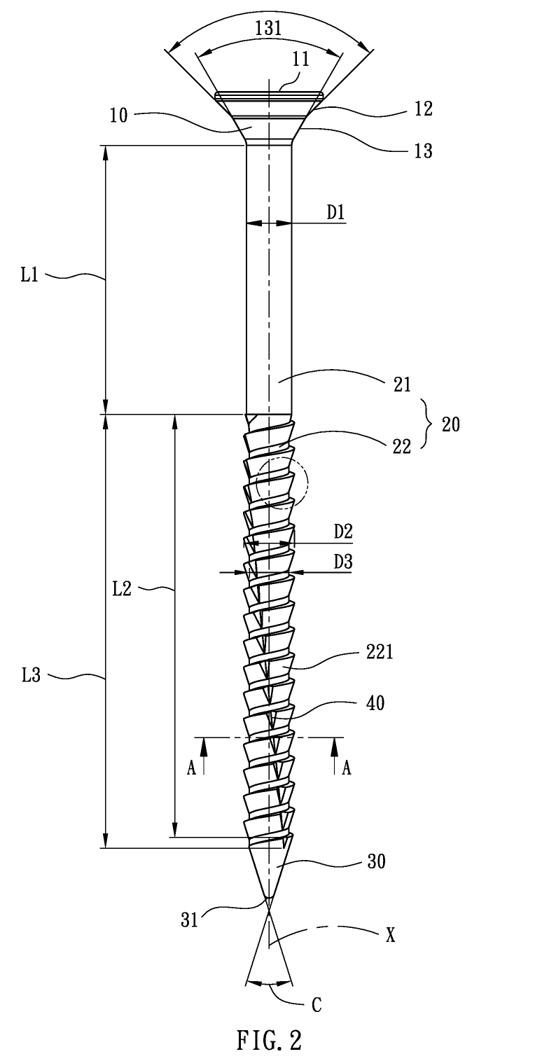

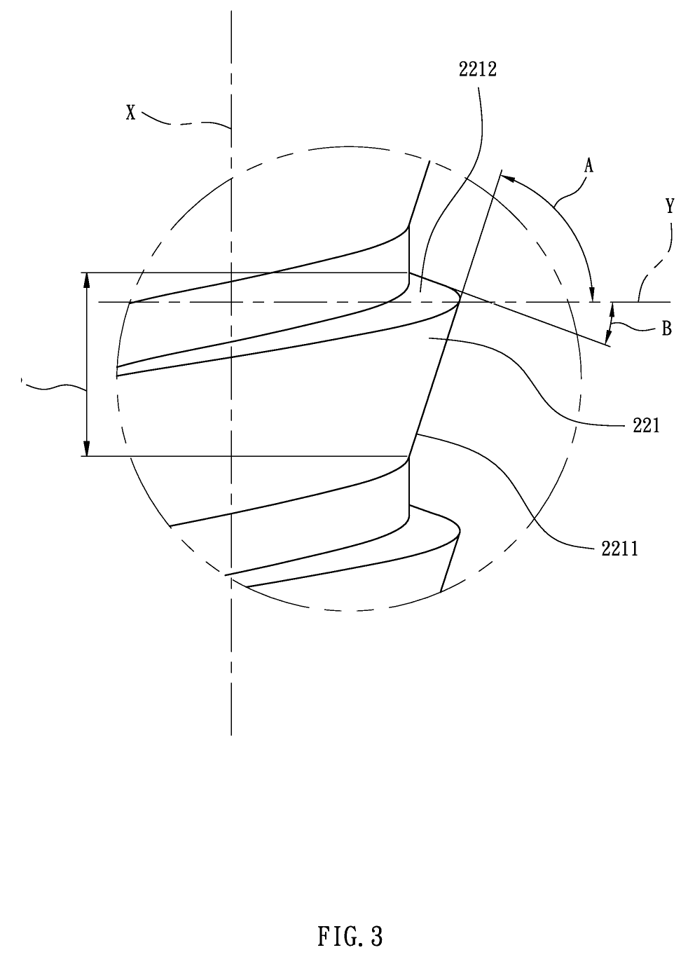

The shaft part 20 is connected with the head part 10. The shaft part 20 comprises a smooth section 21 and a threaded section 22. The smooth section 21 is connected between the threaded section 22 and the head part 10. The threaded section 22 neighbors the tail part 30. The smooth section 21 has a first outer diameter D 1. The threaded section 22 has a second outer diameter D 2 and a thread root diameter D 3. The second outer diameter D 2 is greater than the first outer diameter D 1. Referring to FIG. 2 and FIG. 3, the threaded section 22 comprises a plurality of threads 221. Each thread 221 has a pitch P, and the thread root diameter D 3 is smaller than double the pitch P.

In the embodiment, the thread root diameter D 3 is smaller than the first outer diameter D 1. The pitch P ranges from 1.45mm to 1.85mm. The thread root diameter D 3 ranges from 2.45mm to 2.9mm. In another embodiment, the pitch P is 1.6mm or 1.7mm. In another embodiment, the first outer diameter D 1 ranges from 2.8mm to 3.33mm, and the second outer diameter D 2 ranges from 3.15mm to 3.8mm.

Also, the smooth section 21 has a first axial length L 1, and the threaded section 22 has a second axial length L 2, wherein the second axial length L 2 is greater than the first axial length L 1.

Referring to FIG. 2 and FIG. 3, in the embodiment, each thread 221 has an insertion chamfer 2211 and a gripping chamfer 2212 that are connected. The impact screw 100 defines an axis X and a reference line Y perpendicular to the axis X. The gripping chamfer 2212 and the reference line Y include a gripping angle A, which ranges from 12 degrees to 22 degrees. The insertion chamfer 2211 and the reference line Y include an insertion angle B, which ranges from 67 degrees to 77 degrees. In another embodiment, the gripping angle A is 17 degrees, and the insertion angle B is 72 degrees. Accordingly, when being imposed with the impact force of the nail gun, the impact screw 100 easily enters the to-be-fixed object under the effect of the impact force, and effectively generates a friction with the to-be-fixed object, thereby improving the gripping force of the impact screw 100 to remain at the fixed position.

The tail part 30 is disposed on one end of the shaft part 20 away from the head part 10. The tail part 30 is formed in a conical shape and has a conical angle C, which ranges from 30 degrees to 40 degrees. In another embodiment, the conical angle C is 35 degrees. Also, the tail part 30 has a distal edge 31 formed in an arc shape, and the curvature radius of the distal edge 31 is equal to or less than 1mm, such as, for example, 0.5mm. Accordingly, the conical angle C allows the impact screw 100 to easily enter the to-be-fixed object.

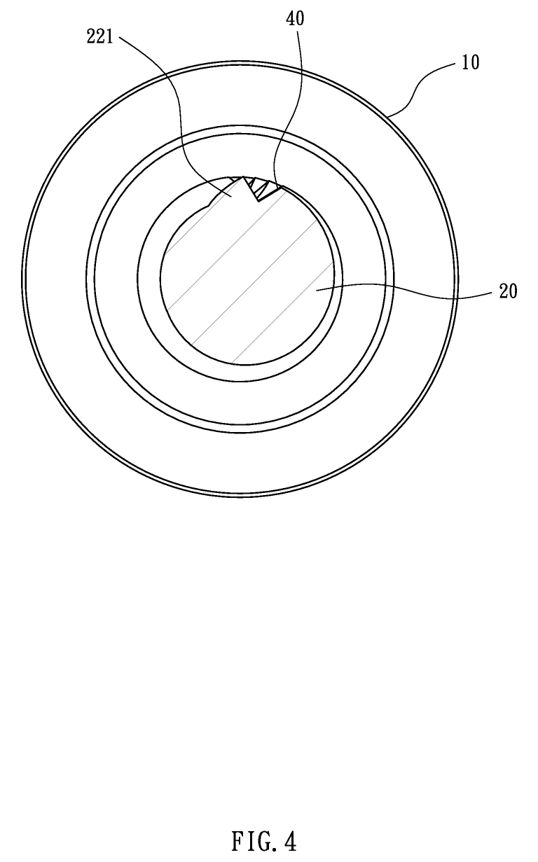

The chip removal groove 40 extends from the threaded section 22 toward the tail part 30. Also, an arrangement direction of the chip removal groove 40 is opposite to a threading direction of the threaded section 22. Referring to FIG. 4, the sectional face of the chip removal groove 40 is formed in a V shape. Accordingly, when the impact screw 100 enters the to-be-fixed object, the chip removal groove 40 facilitates the chip removing and guiding functions, so as to prevent the impact screw 100 from having an excessive resistance, thereby effectively improving the smoothness of the impact screw 100 entering the to-be-fixed object.

In the embodiment, the chip removal groove 40 has a third axial length L 3, which is greater than the second axial length L 2. Therefore, a part of the chip removal groove 40 is formed on the tail part 30, improving the chip removing effect.

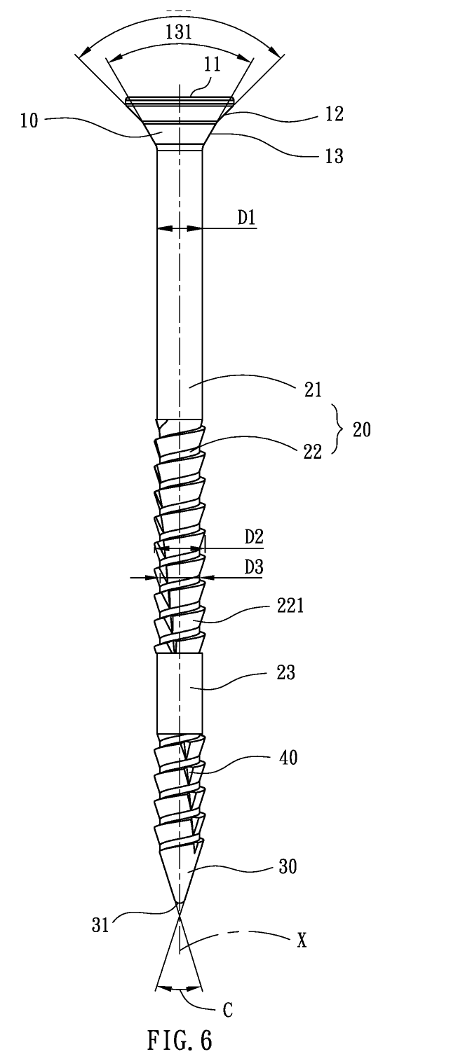

Referring to FIG. 6, the second embodiment of the impact screw 100 a of the present disclosure is provided. The difference of the second embodiment from the first embodiment lies in that the shaft part 20 has a transition area 23. The transition area 23 has a circular sectional face. The transition area 23 is arranged between the smooth section 21 and the tail part 30, but the transition area 23 does not neighbor the smooth section 21 and the tail part 30, so that the transition area 23 divides the threaded section 22 into two sections. Therein, the transition area 23 does not have the thread 221 and the chip removal groove 40.

With the arrangement direction of the chip removal groove 40 being opposite to the threading direction of the threaded section 22, chips are effectively removed, so as to reduce the resistance during the screw penetration process, improve the smoothness of the entering process, and lower the frictional resistance during the process as well.

Although particular embodiments of the disclosure have been described in detail for purposes of illustration, various modifications and enhancements may be made without departing from the spirit and scope of the disclosure. Accordingly, the disclosure is not to be limited except as by the appended claims.

What is claimed is:

1. An impact screw for use with a nail gun, the impact screw comprising:
a head part;
a shaft part connected with the head part, the shaft part having a threaded section and a smooth section, the smooth section connected between the threaded section and the head part, the smooth section having a first outer diameter, the threaded section having a second outer diameter and a thread root diameter, the second outer diameter being greater than the first outer diameter, the threaded section comprising a plurality of threads, each of the threads having a pitch, the thread root diameter being smaller than double the pitch;
a tail part disposed on one end of the shaft part away from the head part; and
a chip removal groove extending from the threaded section toward the tail part, wherein an arrangement direction of the chip removal groove is opposite to a threading direction of the threaded section.

2. The impact screw of claim 1, wherein the tail part has a conical angle, which ranges from 30 degrees to 40 degrees.

3. The impact screw of claim 2, wherein the thread root diameter is smaller than the first outer diameter.

4. The impact screw of claim 3, wherein the smooth section has a first axial length, and the threaded section has a second axial length, wherein the second axial length is greater than the first axial length.

5. The impact screw of claim 4, wherein the pitch ranges from 1.45mm to 1.85 mm; the thread root diameter ranges from 2.45mm to 2.9mm.

6. The impact screw of claim 1, wherein each of the threads has an insertion chamfer and a gripping chamfer that are connected; the impact screw defines an axis and a reference line perpendicular to the axis; the gripping chamfer and the reference line include a gripping angle, which ranges from 12 degrees to 22 degrees; the insertion chamfer and the reference line include an insertion angle, which ranges from 67 degrees to 77 degrees.

7. The impact screw of claim 6, wherein the gripping angle is 17 degrees; the insertion angle is 72 degrees.

8. The impact screw of claim 7, wherein the chip removal groove has a V-shaped sectional face.

9. The impact screw of claim 8, wherein the tail part has a distal edge, which is formed in an arc shape; the distal edge has a curvature radius which is equal to or less than 1mm; the head part comprises a tool groove.

10. The impact screw of claim 1, wherein the head part comprises a top face, a first taper section, and a second taper section; the first taper section is connected between the top face and the second taper section; the second taper section neighbors the shaft part; the first taper section defines a first neck angle, and the second taper section defines a second neck angle, wherein the first neck angle is greater than the second neck angle.

11. The impact screw of claim 10, wherein the first neck angle ranges from 88 degrees to 92 degrees; the second neck angle ranges from 58 degrees to 62 degrees.

12. The impact screw of claim 1, wherein the shaft part comprises a transition area disposed between the smooth section and the tail part; the transition area has a circular sectional face; the transition area does not have the threads and the chip removal groove arranged thereon.
